(19) United States
(12) Patent Application Publication
(10) Pub. No.: US 2002/0103878 A1
(43) Pub. Date: Aug. 1, 2002

(54) System for automated configuration of access to the internet

(76) Inventor: Herbert Moncibais, Dallas, TX (US)

Correspondence Address: Arthur I. Navarro, Navarro IP Law Group, Suite 655, 801 E. Campbell Rd., Richardson, TX, 75081, US

(21) Appl. No.: 09/774,151

(22) Filed: Jan. 30, 2001

(51) Int. Cl. G06F 15/16; G06F 15/177

(52) U.S. Cl. 709/217; 709/222

(57) ABSTRACT

A system 100 for automated configuration of access to a wide area network (80) including an application server computer (112), a communications link (90) providing a signaling pathway for application server computer (112) over a wide area network (80), and a control center (134) accessible by the wide area network (80). The control center (134) is adapted to automatically detect the presence of application server computer (112) on the wide area network (80). Control center (134) is also adapted to provide automatic registration, configuration and protection of the application server computer (112) so that said one or more users are able to achieve access to and use of the wide area network (80). Application server computer (112) includes an interface to the wide area network (128), control software (130) for detecting the type of connection available, and a means for storing user configuration and security information (132).

### TECHNICAL FIELD

This invention relates in general to a system for sharing wide area network access. More particularly, the invention relates to a computerized system for automated configuration of access to a wide area network, such as the Internet, that enables user-friendly setup and use of the network.

### BACKGROUND OF THE INVENTION

Without limiting the scope of the invention, its background is described in connection with the Internet. The Internet or World Wide Web (www) has become a widely-used platform for sharing information. In essence, the Internet provides a wide area network that connects merchants, business people, consumers and other users to each other and permits the interchange of information and the purchase of goods and services from almost anywhere in the world. The communications equipment of the Internet uses a common signaling protocol known as Transmission Control Protocol/Internet Protocol (TCP/IP) for transmitting and receiving information. The communications equipment supporting the protocol includes routers, servers, gateways and other similar devices that together form the infrastructure of the Internet.

Currently, there is high interest in a development of techniques for sharing Internet access. As a result, small business people are discovering and implementing methods of using the Internet among their own employees. Typically, the result has led to a company acquiring a large number of different types of computers and computer related hardware and accessories. These include servers, firewalls, fax machines, e-mail servers, web servers, and other types of hardware and software to fulfill the needs of the small business market in network connectivity.

For example, currently, small business owners purchase a server, which can be a large complicated expensive computer, to act as a central point for their Internet services. Next, they have to purchase a separate firewall to protect the server from hostile invaders that are lurking outside on the Internet. Further, they have to purchase a virus protection program. Finally, they have to provide an information technology specialist on their staff to keep the server, the firewall, virus protection, and other parts functioning. In addition to the purchase of equipment and software, it is also necessary to subscribe to a provider service which will provide the desired level of Internet connectivity. Alternatively, the business may commit only a fraction of its computers to the Internet and purchase appropriate software for each computer accessible to the Internet. The Internet connectivity may include e-mail, web hosting, and other types of information storage and delivery capabilities.

From the prospective of the small business owner, the use of such equipment for Internet connectivity may be disfavored or unlikely for several reasons. First, the purchase of a server may unduly strain the financial resources of a small company due to the large cost for an asset that will typically depreciate quickly over time. The second disadvantage is the requirement for a large number of different servers and software solutions to work together. It is often difficult for the small business owner to evaluate what they need, much less whether or not the products they have purchased are compatible and actually producing the desired results. Another disadvantage of the prior art is the requirement of a dedicated information technology specialist to keep the equipment running.

Accordingly, a need exists for a way of sharing Internet access between all designated employees of a company without putting an undue burden on the financial resources of a company or requiring additional dedicated personnel to run the equipment. A system that provides automated configuration of access to the Internet and sharing among users would provide numerous advantages over the prior art.

### SUMMARY OF THE INVENTION

The present invention provides a system for automated configuration of access to a wide area network, such as the Internet. The system comprises an application server computer, a communications link and a control center. The application server computer has an interface to the Wide Area Network (WAN) and control software capable of detecting the type of connection available for use by the server and for configuring the server for use of the WAN by one or more users. Finally, the application server computer has a means for storing the user configuration and security information required to describe user access for the WAN. The control center is a remote center accessible over the WAN by the application server computer and which is adapted to automatically detect the presence of the application server computer on the WAN. The control center is also adapted to provide automatic registration, configuration and protection of the application server computer so that one or more users are able to achieve secure access to and use of the WAN.

The communications link may be a T-1 phone line, a Digital Subscriber Line (DSL), an Integrated Services Digital Network (ISDN), Ethernet, or other types of network communications mediums known to those skilled in the art.

In yet another embodiment of the invention, the control software further includes a firewall, which is used to protect users from unauthorized access and computer viruses that may try to reach into the user's computer from outside on the WAN.

Furthermore, the application server computer can include means for facsimile (fax) communications which allow electronic images to be transmitted from one location to another location.

According to another embodiment, disclosed is an application server computer for providing automated access to a WAN such as the Internet. The application server computer is capable of accessing a WAN by one or more users through a single interface to the WAN. The application server computer has control software which detects the type of connection available to the WAN and configures the application server computer for use on the WAN. The application server computer also includes a means for storing user configuration, and security information which describes each user's level of access and capabilities. The application server computer is also capable of accessing a control center over the WAN so that the application server computer may be registered, configured and protected from unauthorized use. In addition, the application server computer may be monitored and adapted for receiving software updates from the control center via the WAN.

In another embodiment, the application server computer includes a firewall which can protect users from unauthorized third party access and a virus protection program. The firewall further comprises a Network Address Translator (NAT) which allows end user computers to appear as one computer to other computers on the WAN. A means for utilizing one e-mail domain on the application server computer to allow users to access e-mail across the WAN is also provided. A spam blocking system is included in the e-mail capabilities. Spam is unsolicited e-mail similar to junk mail in the postal mail system. The application server computer also includes a means for several end user computers to be simultaneously connected to a WAN through a singe Internet Service Provider (ISP) account.

Disclosed in yet another embodiment is an application server computer having a Virtual Private Network (VPN) which allows one or more computers to communicate via the WAN without utilizing public phone lines. The application server computer further comprises a means for caching World Wide Web pages so that previously viewed pages may be called up by an end user in a much faster manner. The caching means will store a determined quantity of cached data for a determined length of time, or a combination based on time and quantity.

Further disclosed is a software implemented program product for use on an application server computer that facilitates the sharing of an Internet connection amongst several users. The program product is adapted to cause the application server computer to achieve automated configuration of access to a WAN by one or more users. The program product includes an interface to the WAN, control software for detecting the type of connection available for use by the application server computer and for configuring use of the WAN by one or more users. The program product also includes a means for storing user configuration and security information. The user configuration and security information allows the application server computer to know who should be able to access the application server computer, how they should be able to access the application server computer and how much access they should have to the application server computer. In another embodiment, the program product further includes a firewall and a virus protection program. The firewall and virus protection program are used to protect end users from outside hackers, unauthorized users and viruses.

In another embodiment, the program product may include facsimile communications software. The facsimile communications software will allow the application server computer to communicate with facsimile machines to transmit and receive electronic images which can be transferred to paper. In another embodiment, the program product includes virtual private network software which allows several computers on different networks to communicate across the WAN without using public phone lines. In yet another embodiment, the program product includes a unique identification number which is used to provide an identity to the control center so the program product may not be illegally copied or used by improperly authorized individuals.

In another embodiment, the program product includes a means for logging IP addresses of computers communicating with the program product over the WAN. This allows the program product to keep a record of everyone it communicates with so if a problem is created, it is possible to track down the source. The program product further includes a logic means for accepting a Global Positioning Satellite location signal (GPS) and logic means for communicating the GPS location signal to the control center.

An advantage of the present invention is that it frees the small business owner from having to invest large amounts of money into a complex server to achieve access to a WAN such as the Internet.

Another advantage of the present invention is that it frees the small business owner from having to have a dedicated staff member who understands information technology and knows how to configure access to and use of the Internet.

Still another advantage of the present invention is that it allows the small business owner to pick and choose the exact combination of access tools that he needs to conduct his business.

### BRIEF DESCRIPTION OF THE DRAWINGS

For a more complete understanding of the invention, including its advantages and specific embodiments, reference is made to the following detailed description along with the appended drawings in which:

FIG. 1 is a pictorial representation of a computer system in which the control software, software-implemented program product and the application server computer of the present invention may be implemented, according to one embodiment;

FIG. 2 is the representative hardware environment of the computer system of FIG. 1;

FIG. 3 is a block diagram of the client server architecture that can be employed in a Wide Area Network, such as the Internet, in order to implement the system of the present invention, according to one embodiment;

FIG. 4 is a block diagram of the client server architecture that facilitates access by a user to a web based application, according to the invention;

FIG. 5 is a block diagram of a computer network in which the present invention can be implemented, according to one embodiment;

FIG. 6 depicts the system for automated configuration of access to the Internet, according to one embodiment of the invention;

FIG. 7 illustrates other aspects of the system of FIG. 6, according to one embodiment of the present invention;

FIG. 8 illustrates shared e-mail, according to one embodiment of the present invention;

FIG. 9 shows the use of a GPS location signal in connection with an application server computer, according to one embodiment of the present invention;

FIG. 10 depicts the application server computer, according to one embodiment of the present invention;

FIG. 11 illustrates a program product, according to one embodiment of the present invention;

FIG. 12 depicts a loaded program product, according to one embodiment of the present invention; and

FIG. 13 illustrates the functional details and contents of an application computer server, according to one embodiment of the invention, suitable for achieving automated configuration of access to the Internet.

References in the detailed description correspond to like references in the figures, unless otherwise indicated.

### DETAILED DESCRIPTION OF PREFERRED EMBODIMENTS

While the making and using of various embodiments of the present invention are discussed in detail below, it should be appreciated that the present invention provides many applicable inventive concepts which can be embodied in a wide variety of specific contexts. These specific embodiments discussed herein are merely illustrative of specific ways to make and use the invention, and do not delimit the scope of the invention.

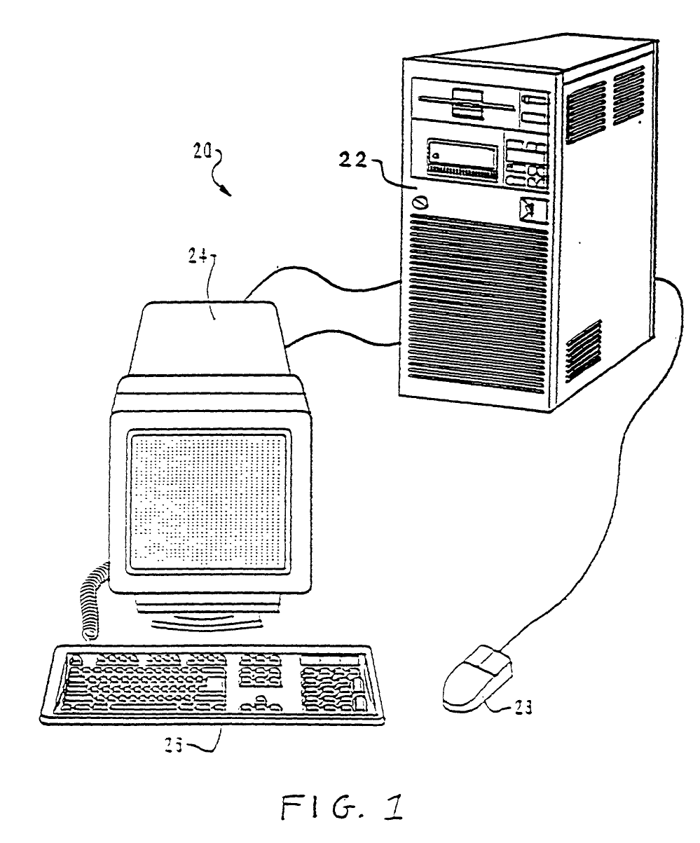

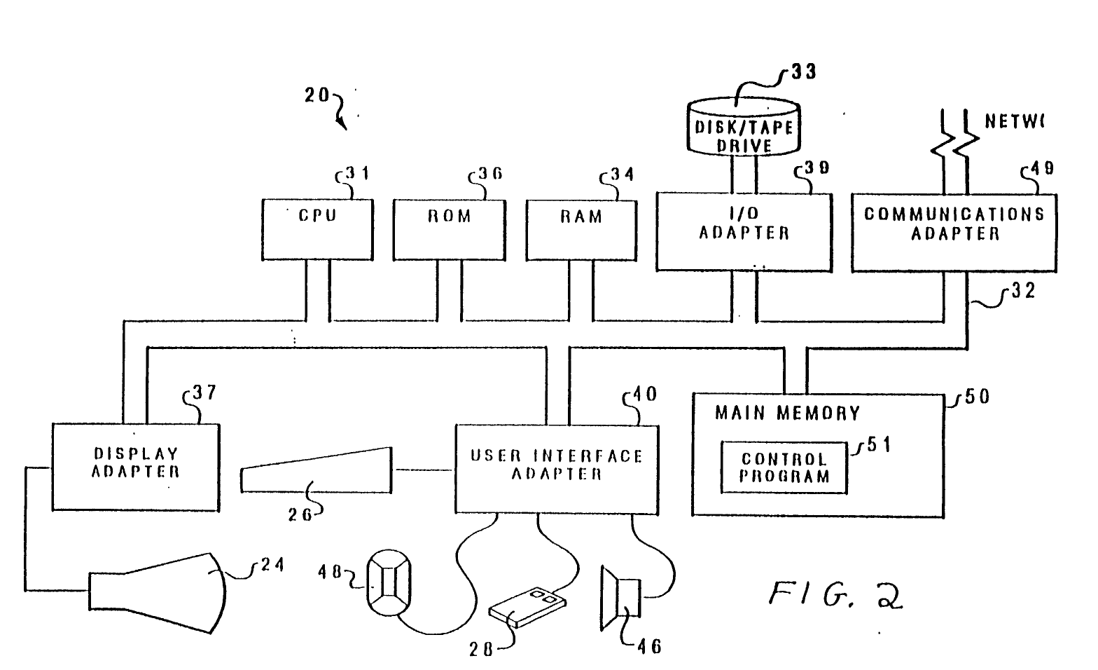

With reference now to the figures, and in particular to FIG. 1, therein is shown a computer system 20 in which the application server computer of the present invention can be developed, configured, and utilized, according to one embodiment. Specifically, it is assumed that one skilled in the art, upon reference to this disclosure, would be able to adapt a computer system, such as a computer system 20, to perform the functions of an application server computer, as herein described. The computer system 20 is shown to include a system unit 22, a video terminal 24, a keyboard 26 and a mouse 28. Typically, the system 22 unit houses all of the various functional and operation components, accessories, and devices including stored programs or software which allow the computer system 20 to function. Those skilled in the art will appreciate that the method and system of the present invention apply equally to other computer systems, regardless of whether the computer system is a complicated multiuser platform or a single user workstation. In FIGS. 1 and 2, like parts are identified by like numbers.

FIG. 2 illustrates the representative hardware which a computer system 20 may utilize, according to the invention. The computer system 20 includes a Central Processing Unit (“CPU”) 31, such as a conventional microprocessor, and a number of other units interconnected via a system bus 32. Such components and units of a computer system 20 can be implemented in a box or other platform such as a system unit 22 of FIG. 1. The computer system 20 further includes Random Access Memory (“RAM”) 34, Read Only Memory (“ROM”) 36, display adaptor 37 for connecting system bus 32 to video display terminal 24, and I/O adapter 39 for connecting peripheral devices (e.g., disc and tape drives 33) to system bus 32.

A video display terminal 24 is the visual output of the computer system 20 and can be used, for example, to allow a user of the computer system 20 to view the contents of a web site over the Internet. The arrangement of the Internet and other similar wide area network topologies will be discussed below. A video display terminal 24 can be a CRT-based video display, well known in the art of computer hardware. However, with a portable or notebook-based computer, video display terminal 24 can be replaced with an LCD-based or a gas plasma-based panel display as well as other similar display configurations that are available in the industry. The computer system 20 further includes a user interface adaptor 40 for connecting the keyboard 26, mouse 28, speaker 46, microphone 48, and/or other customer related interface devices, such as a test screen device (not shown) to the system bus 32. Communications adaptor 49 connects computer system to a computer network such as, for example, the Internet. Although the computer system 20 is shown to contain only a single CPU and a single system bus, it should be understood that the present invention applies equally to computer systems that have multiple CPU's and to computer systems that have multiple busses wherein each perform different functions in different ways.

Computer system 20 also includes a logic that resides within machine readable media to direct the operation of computer system 20. Any suitable machine readable medium may retain the logic, such as RAM 34, ROM 36, a magnetic diskette, magnetic tape, or optical disk (the last three being located in disc and tape drives 33). Any suitable operating system and associated interface, such as, for example, Microsoft Windows, may direct and cause the operation of CPU 31. Other technologies can also be utilized in conjunction with the CPU 31, such as a touch screen technology or human voice control. In addition, those skilled in the art will appreciate that the hardware detected in FIG. 2 may vary for specific applications. For example, other peripheral devices, such as an optical disc media, audio adaptors, or chip programming devices such as PAL or EPROM programming devices well known in the art of computer hardware and the like may be utilized in addition to or in place of the hardware already depicted.

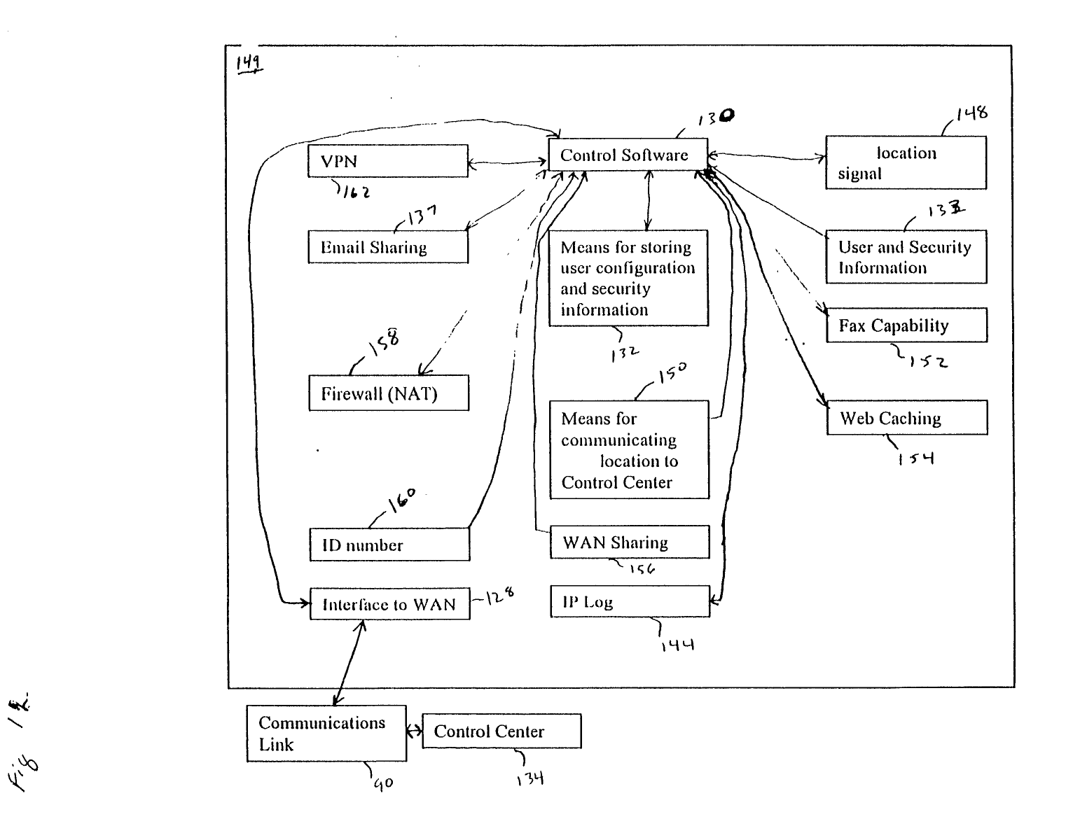

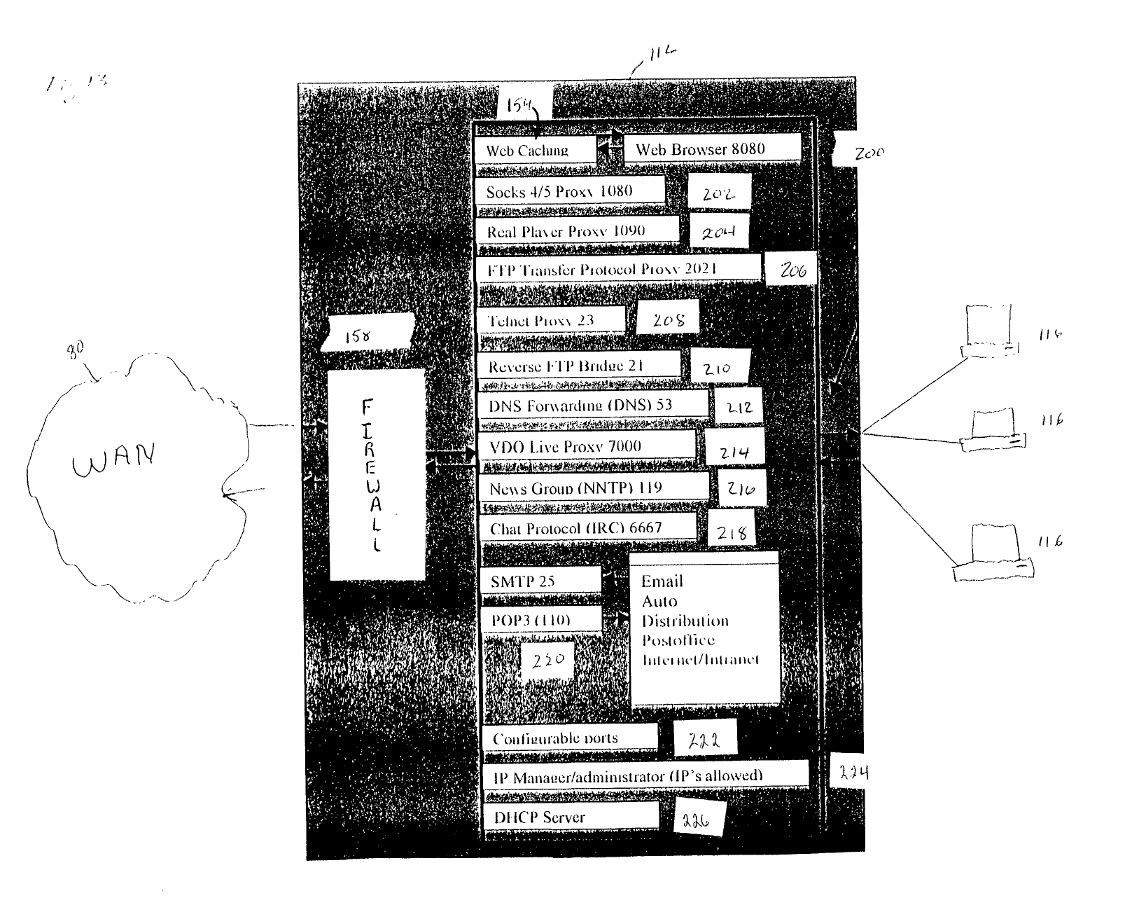

Main memory 50 is connected to system bus 32 and includes a control program 51. Control program 51 resides within the main memory 50, and contains instructions that when executing on CPU 31, carries out the operations of the computer system 20. In this regard, a computer program or software-implemented program product can be created to incorporate the required logic, software instructions and program sequences necessary, in conjunction with CPU 31, to carry out the operations and function of the processes described in FIGS. 11 and 12.

It is important to note that, while the present invention has been (and will continue to be) described in the context of a fully functional computer system, those skilled in the art will appreciate that the present invention is capable of being distributed as a program product or software application in a variety of forms, and that the present invention applies equally, regardless of a particular type of signal bearing medium utilized to carry out the system and program product of the present invention. Examples of such signal bearing medium include: recordable type media, such as floppy discs, hard drives and CD ROMS, and tradition type media, such as digital and analog communication links, fiber optic wiring, and communications components utilized in wide area network such as the Internet.

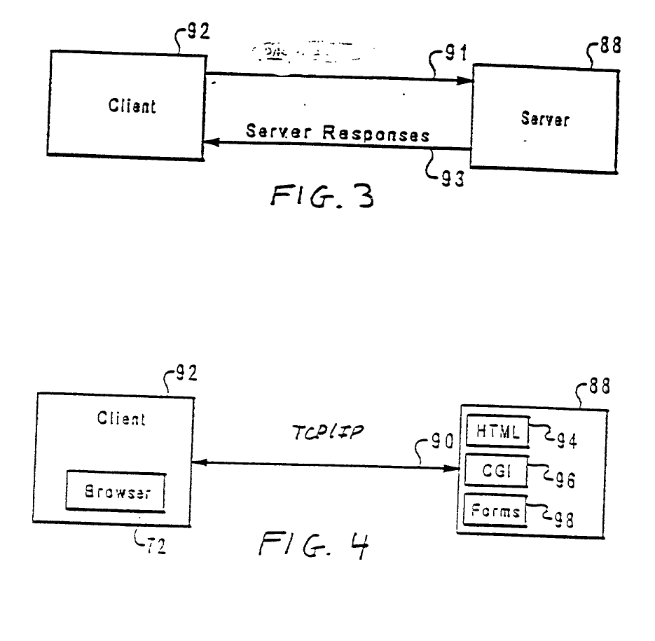

In FIGS. 3, 4 and 5, like parts are indicated by like numbers. Specifically, FIG. 3 illustrates a block diagram of a client server architecture that can be used by a client or user (even those not even utilizing a computer processing platform, such as computer system 20), to access a server 88 which would host an application of one or more services on the Internet. It should be understood that the word “Internet”, as used herein, includes many types of wide area network configurations which can be utilized to provide access by numerous users to the services of numerous other users.

In FIG. 3, a client selection 91 is transmitted by the client application program 92 to a server 88 hosting the application. Server 88 can be a remote computer system accessible over the Internet or other similar wide area network. The client application program 92 may be utilized in association with a computer, such as computer system 20 of FIG. 1, and the implementation of computer system 20, as illustrated in FIG. 2. Server 88 sends a response 93 to answer the selection 91 from the client.

FIG. 4 illustrates the client server architecture in a WAN in more detail, in accordance with one embodiment suitable for implementing the invention. Although the client and server are processes that are operative within two computer systems, these processes can be implemented using a programing language to create a set of instructions and software related algorithms which are interpreted and executed in a computer system, such as computer system 20, as is appreciated by those of ordinary skill in the art. As shown, the client 92 and server 88 communicate over a communications link 90, in this case, by utilizing the functionality provided by the Transmission Control Protocol/Internet Protocol (“TCP/IP”), which is a communications protocol well known to those of ordinary skill in the art. A browser 72 is an application active within the client 92 which establishes connections with the server 88. Information can be presented to the user at the client 92 via the browser 72. Any number of commercially or publicly available browsers can be utilized in various implementations in accordance with the invention. For example, the mosaic browser available by the National Center for Supercomputing Applications (NCSA) in Urban-Champagne, Ill., can be utilized in accordance with a preferred embodiment of the present invention. Other browsers, such as Netscape™ and Microsoft Explorer™ also provide the ability to communicate with the server 88 using TCP/IP. “Netscape” is a trademark of Netscape, Incorporated while Microsoft Explorer is a trademark of Microsoft, Incorporated.

Server 88 executes corresponding server software and related instructions to present information to the client 92 over the WAN using TCP/IP. Responses from the server 88 can correspond to web pages represented and arranged using HyperText Markup Language (HTML) 94 or other data generated by the server 88. The server 88 provides the HTML 94 application and with certain browsers, such as the Mosaic brand browser described above, a Common Gateway Interface (CGI) 96 is also provided, which allows the client application program 92 to direct server 88 to commence execution of a specified software program product contained within the server 88. This may include the operation of a search engine that scans information stored in the server 88 for presentation to a user controlling the client application 92 via his or her computer system 20. A specific example would involve a merchant placing his goods and services on a server 88 which are arranged in one or more web pages (collectively the ‘merchant web site’) using an HTML 94 application so that a customer utilizing the client application program 92 can view, price and place orders for such goods and services.

By utilizing the client server architecture illustrated in FIGS. 3 and 4, and the TCP/IP, the server 88 may notify a user of the results of execution upon completion. CPI 99 is one form of a gateway, which provides a mechanism to connect dissimilar networks (i.e., networks utilizing different communications protocol) so that electronic information can be passed from one network to another. This facilitates access by numerous client topologies to information stored on numerous and different computing platforms as is well known to those of ordinary skill in the art.

In order to facilitate the process of viewing the information on the server 88 and providing data and entering information, the client application 92 may direct the browser 72 to use a secure link and/or software encryption and/or other forms of security in order to keep the user's information confidential. This functionality allows users to access the server 88 and any web pages or other information contained therein with confidence and knowledge that their confidential information will be kept confidential.

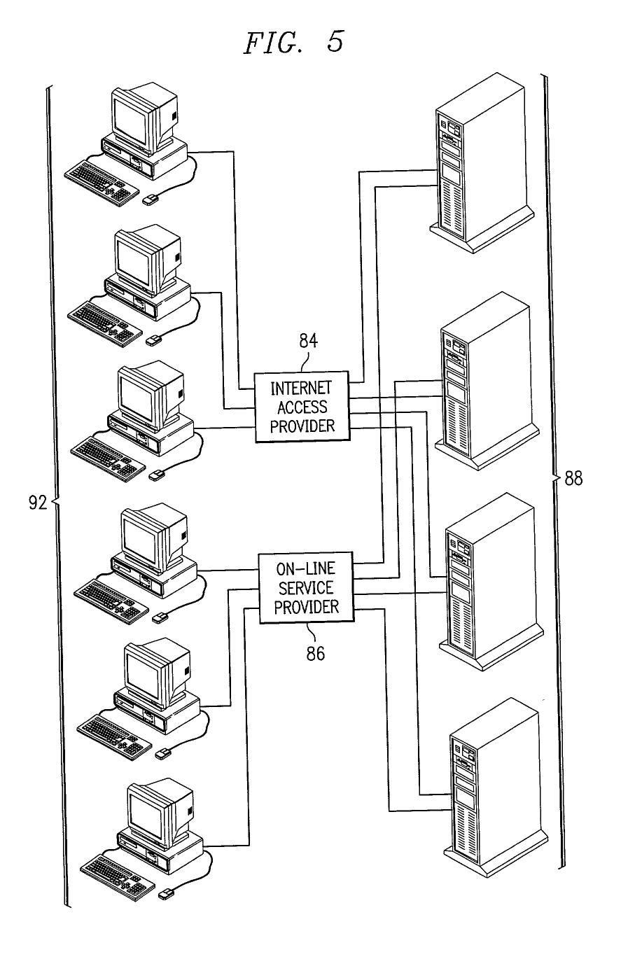

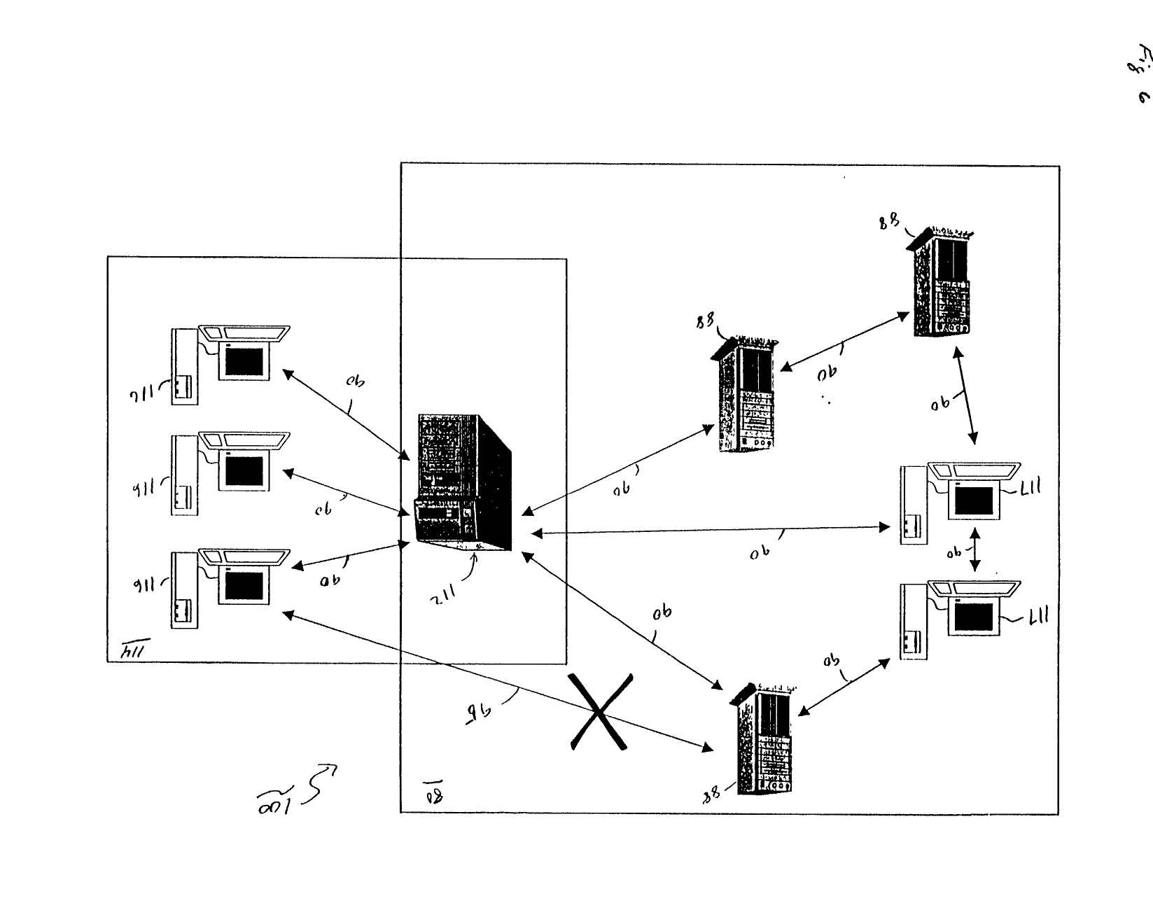

Having described the general architecture of a wide area network (WAN), such as the Internet, which can be accessed by numerous individuals to share information and communicate with each other, reference is made to FIG. 5 which illustrates a WAN 80 providing access to a plurality of clients 92 and a plurality of applications contained in multiple server platforms 88. Specifically, WAN 80 is representative of a network topology, such as the Internet. The Internet includes a large network of servers 88 that are accessible by clients 92, typically customers utilizing computer systems such as the computer system 20, to gain access to the Internet, typically through an Internet service provider 84 or an online service provider 86. Each of the clients 92 may run a browser 72 to access servers 88 via the service providers 84 and 86. Each service provider 88 operates a so-called “web site” that supports files in the form of documents and pages and, as such, is referred to as hosting the web site. In addition, multiple web sites can also be executed from one server. A network path to service 88 is identified by a Universal Resource Locator (URL) having a known syntax for defining a network collection. Computer network 82 must be considered a web-based computer network.

As described above, a particular problem faced by users of a WAN 80, especially small businesses with multiple users desiring access to the Internet, is providing and configuring access to the network. This is especially difficult in the small business environment wherein multiple users need access but the costs associated with providing access, configuring users and updating changes and modifications to the system by a dedicated network support specialist would be prohibitive. Accordingly, the present invention provides an automated way of configuring access to the Internet or other similar WAN.

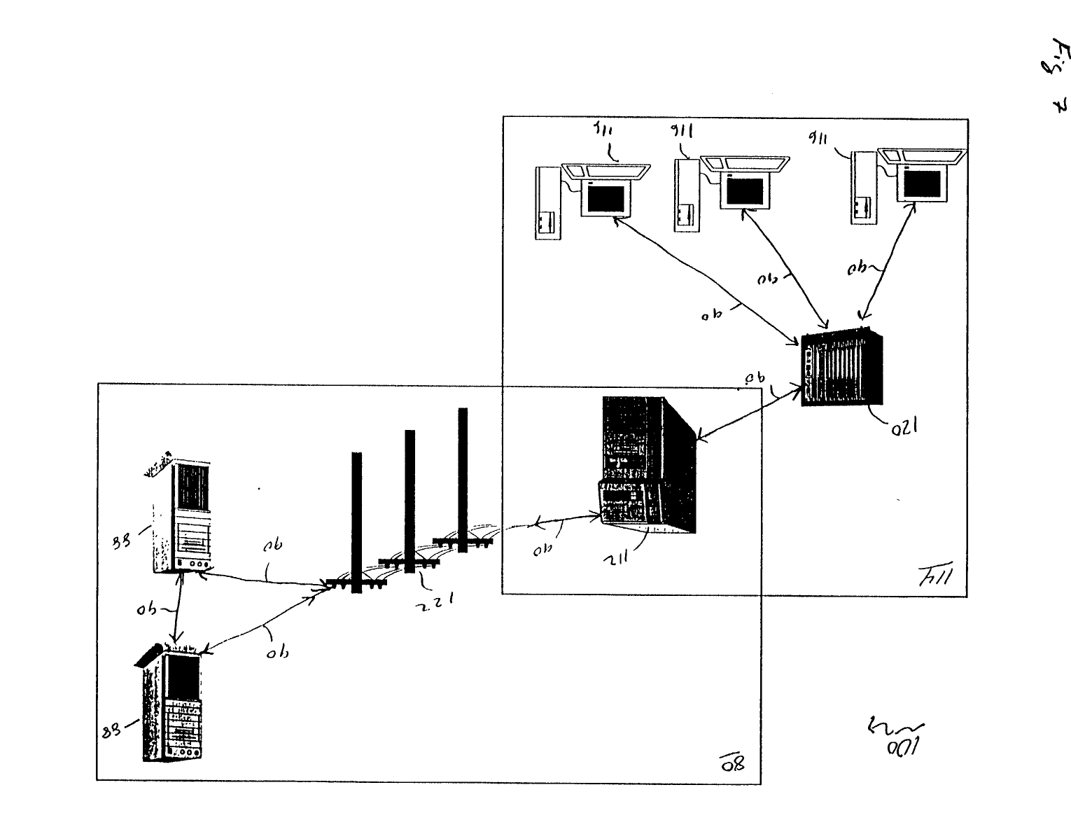

Having described the hardware, software and networking environment in which the present invention can be implemented and to the extent that such descriptions enable one of ordinary skill in the art, a discussion of the system of of the present invention providing automated configuration of access to the Internet is shown and denoted generally as 100 in FIG. 6.

System 100 includes a WAN 80 and an internal network 114. End user computers 116 are located within internal network 114 and cannot be directly accessed by computers on the WAN 80. Application server computer 112 is located in the union between internal network 114 and WAN 80. Essentially, the application server computer 112 provides the functions of a “web” server, as is known in the art, plus other functions that permit automated configuration of access to WAN 80. Specific details of an application server computer 112 suitable for this purpose will be discussed below in reference to FIG. 13. That is, application server computer 112 is accessible to both the WAN 80 and the internal network 1 14 so that users of the internal network 114 have access to WAN 80. Application server computer 112 is the only part of internal network 114 that is directly accessible to the WAN 80. WAN 80 is made up of Internet end users 117 and servers 88. All of these computers are connected by communication links 90.

On the WAN 80, the computers can talk to each other through various routes established by communication links 90. However, for any of the computers on the WAN 80 to talk to any of the computers on the internal network 114, all communications must go through the application server computer 112. Thus, application server computer 112 is a focal point for which all communications between WAN 80 and internal network 114 must pass through. An impossible communication link 95 is illustrated between server 88 on the WAN 80 and end user computer 116 on the internal network 114. For example, since all communications between WAN 80 and internal network 114 must pass through application server computer 112, it would not be possible for any of the end user 116 to talk directly with any other computer, such as server 88.

The fact that all communication between WAN 80 and internal network 114 must go through the application server computer 112 allows application server computer 112 to serve as a firewall. As a firewall, application server computer 112 limits what computers and what types of communication may pass between WAN 80 and internal network 114. Application server computer 112 thus protects end user computers 116 on internal network 114 from hackers and unauthorized access since it is the focal point for which all entry into the internal network 114 from WAN 80 must be made. Application server computer 112 can include a virus protection program to protect computers 116 on internal network 114 from computer viruses.

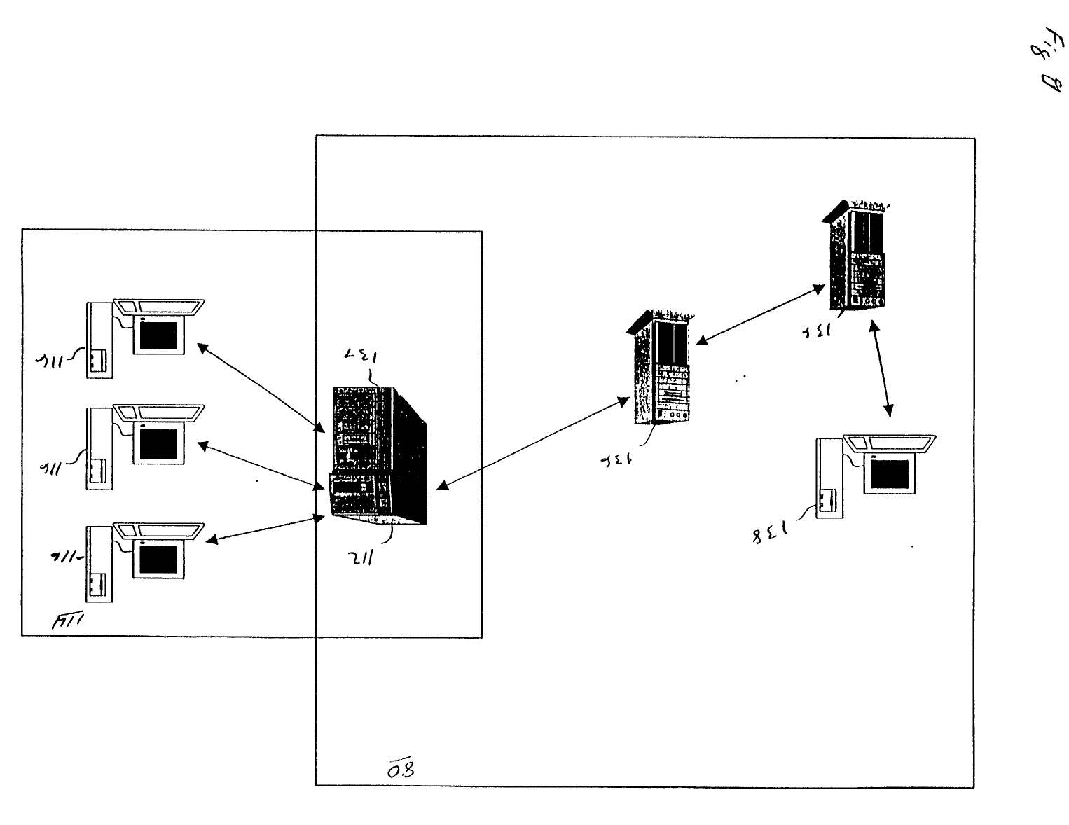

FIG. 7 illustrates a preferred implementation of the system 100 of the invention. System 100 includes a WAN 80 and an internal network 114. The internal network 114 is comprised of one or more internal users represented by end user computers 116. End user computers 116 are connected through communication link 90 to a router 120. The router 120 is then connected to application server computer 112 by communication link 90. Within internal network 114, communication link 90 will typically be Ethernet connections, although other networking standards and protocols may be employed.

WAN 80 is a wide area network such as the Internet, which is comprised of a plurality of computers such as servers 88. Servers 88 are connected through communication links 90 so that each computer can talk to each other through a multitude of different routes. Application server computer 112 is also connected to the WAN 80 through a communication link 90. For high speed access, the communication link may be a T-1 line 122, which provides high capacity, fast communications capable of supporting the bandwidth requirements of a small business owner. Alternatively, the T-1 line 122 may be replaced with an analog telephone line, a Digital Subscriber Line (D.L.), an Integrated Digital Services Network (ISDN) line, Cable wide area network connection (cable modem), wireless wide area network connection or other methods known to those skilled in the art.

When an end user computer 116 requires information from server 88 on WAN 80, a communication is sent from the end user computer 116 through router 120 to application server computer 112 and to server 88. All of these communications between these various machines travel over communication links 90. The communication links 90 may be any of several different types, such as Ethernet, telephone line, ISDN, T-1, D.L. or other methods known to those skilled in the art. In fact, a typical installation will have numerous different types of communication links 90 between each different computer in the network. Application server computer 112 acts as a watchdog and is configured to only allow certain types of communication in and certain types of communication out. In another embodiment, it includes the ability to log all IP addresses communicating with it; that is, it makes a notation of each computer it talks to so that if a problem develops, it can be traced back to the offending computer. For example a problem could be unauthorized access, a computer virus, or other fault producing conditions.

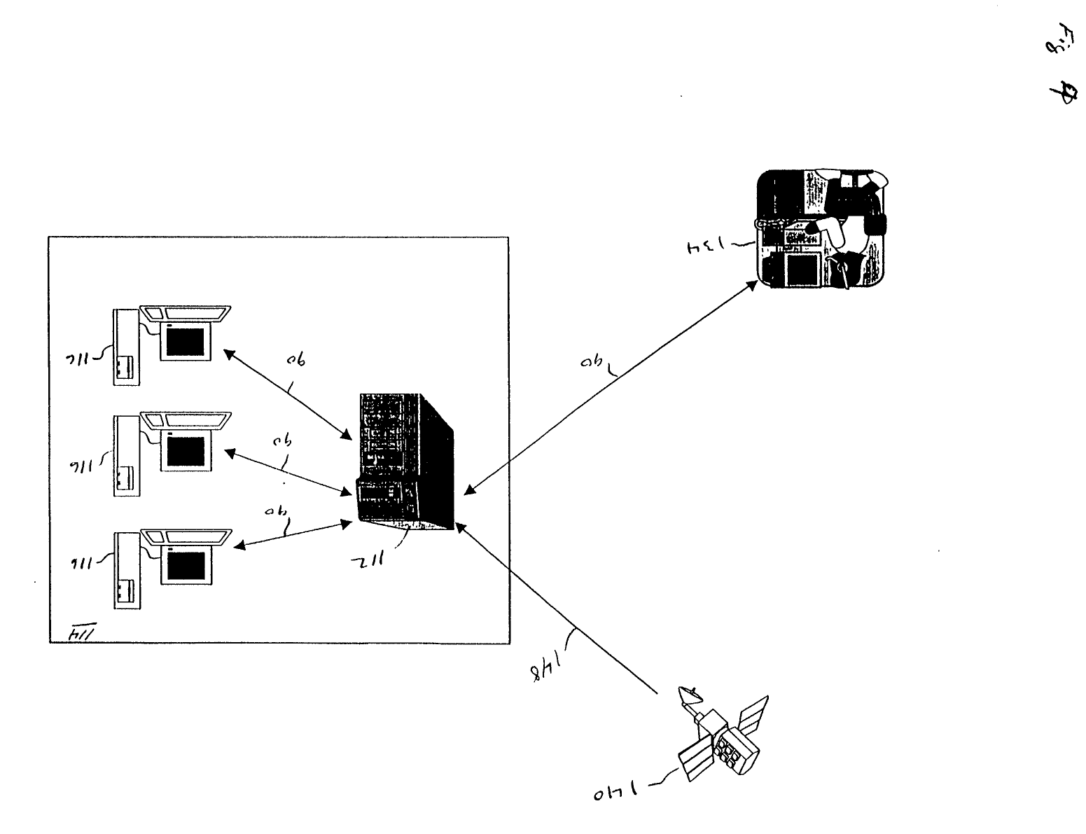

FIG. 8 shows the application server computer 112 of the invention which includes a means for utilizing one e-mail domain 137. As illustrated, internal network 114 contains end user computers 116 and application server computer 112. Application server computer 112 contains means for utilizing one e-mail domain 137 which allows it to correctly route incoming and outgoing e-mail. Internal e-mail is routed without ever crossing outside of internal network 114. WAN 80 has an e-mail user 138 which sends e-mail to e-mail server 136. As e-mail is routed through the system, it crosses another e-mail server 136, then reaches application server computer 112. Application server computer 112 uses means for utilizing one e-mail domain 137 to correctly route the e-mail to the desired end user computer 116. Thus, application server computer 112 allows for e-mail to be correctly routed between different end user computers 116 on internal network 114.

For example, means for utilizing one e-mail domain 137 may include e-mail filtering software, e-mail serving software, or other similar techniques. E-mail filtering software routes e-mail based on a set of user defined rules or filters. An e-mail server is a software program that receives e-mail from e-mail clients and servers. A typical e-mail server consists of a storage area, a set of user definable rules and a series of communication modules. An alternative embodiment of application server computer 112 has a means for retrieving e-mail for users from a WAN 80. A typical means for retrieving e-mail is a e-mail client program.

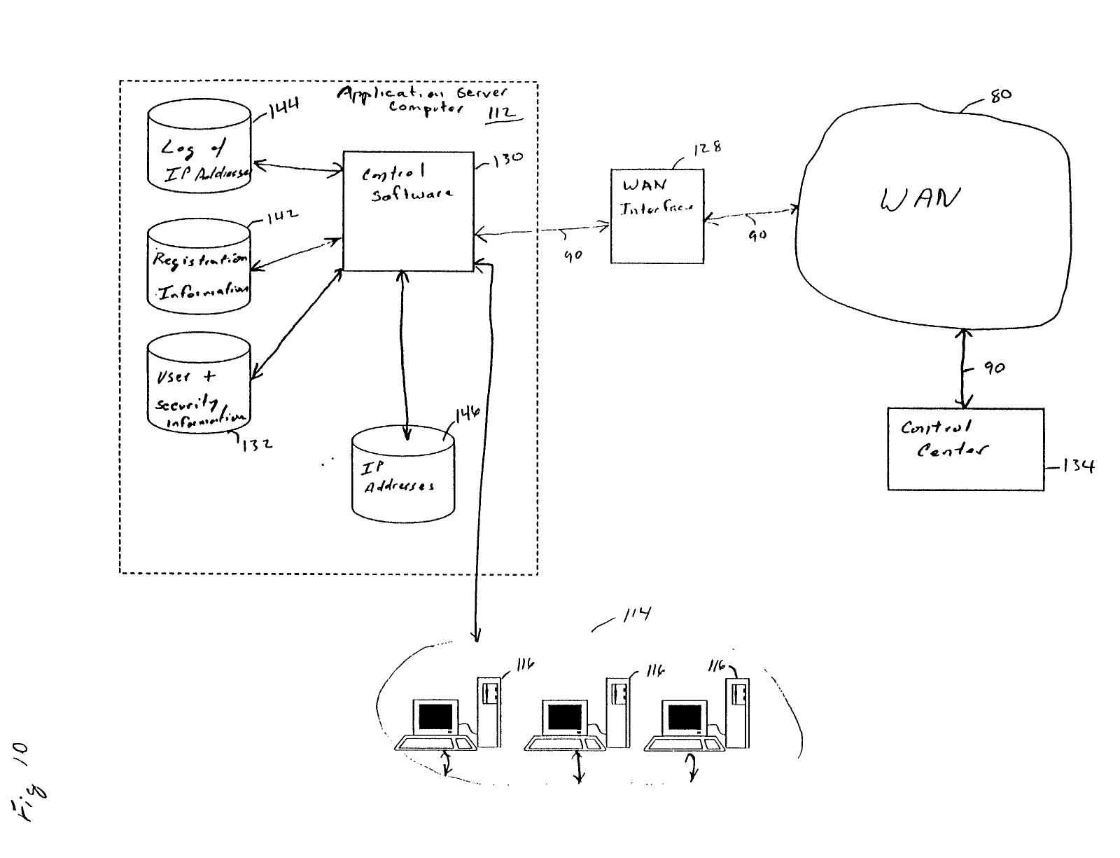

A feature of the system of the present invention is shown in FIG. 9 which illustrates the application server computer 112 includes a location capability in the form of a GPS location capability. Specifically, application server computer 112 is capable of receiving a GPS location signal 148 from a GPS satellite 140. Application server computer 112 can then communicate its location over communication link 90 to control center 134. Thus, if the location of application server computer 112 does not match the location that the control center 134 has in its record, the control center 134 can contact the owner to determine if the application server computer 112 has been stolen or moved. Application server computer 112 continues to function on internal network 114 as the focal point for end users to connect to WAN 80 over communication links 90. The GPS location function of application server computer 112 is a useful tool for allowing small business owners to sleep better at night knowing that their investment is traceable, if stolen.

Control center 134 also has a means to update application server computer 112 and a means to troubleshoot application server computer 112. Application server computer includes means for receiving updates from the control center 134 and a means for receiving troubleshooting from the control center 134. These functions together to allow the control center 134 to remotely install new or updated software and fix or reconfigure existing programs. This saves time and money since a technician does not have to make an on-site visit to application server computer 112.

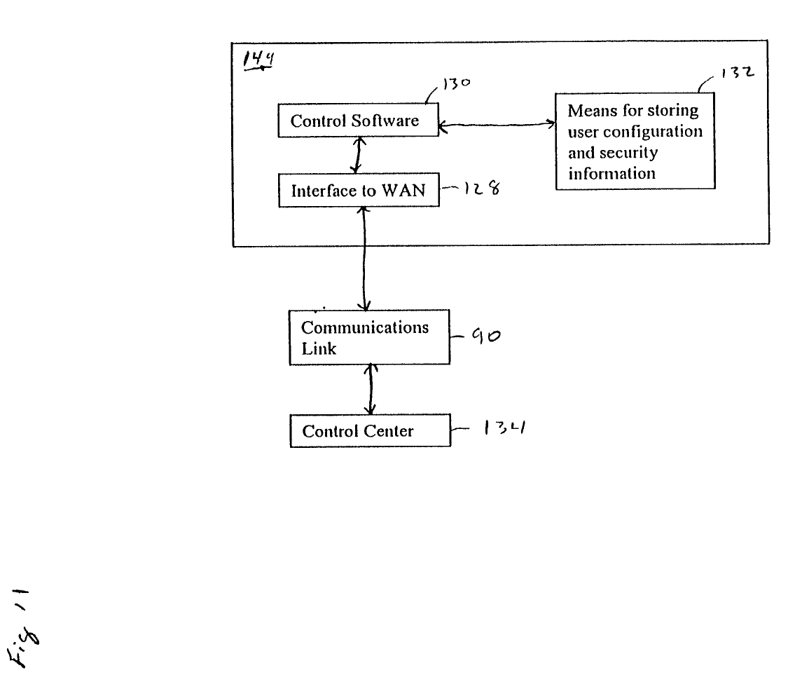

FIG. 10 illustrates the application server computer 112, according to one embodiment of the invention. Application server computer 112 is a computer including control software 130, which is designed to control the functions of application server computer 112. Further, control software 130 maintains a log of IP addresses 144 so that each computer that communicates with application server computer 112 is logged by address. IP addresses are a naming convention used by computers on a WAN, such as the Internet. The typical naming convention is four sets of numbers. Each of the numbers is between 0 and 255. Thus, a typical address might be 63.71.228.67. Those skilled in the art will recognize that this numeric IP address may be aliased to another address through a Domain Name Server (DNS). For example, this IP address, 63.71.228.67, is analogous to www.uspto.gov. Thus, it would be possible, through the log of IP addresses 144, to locate and confirm what computers have been accessing computers on the internal network 114.

IP logging is useful if a problem develops, such as end user computers 116 contacting undesirable web sites or if external users on the WAN 80 are trying to hack in and gain unauthorized access to end user computer 116 on the internal network 114. The control software 130 also interacts with registration information 142. Registration information 142 is communicated over WAN 80 to control center 134 so that the identity of application server computer 112 can be verified and allow maintenance or diagnostic checks to be conducted.

Further, control software 130 interacts with a means for storing the user security information 132 which provides control information so that control software 130 will know what types of access to allow each end user computer 116 and what types of access to allow external Internet end users 117 coming in from the WAN 80. Thus, it is possible to set up different levels of access for different individuals within the company. Control software 130 also interacts with a list of IP addresses 146 which establishes valid IP addresses for using the system. Additionally, control software 130 also interacts with the WAN interface 128 which allows the application server computer 112 to be connected to WAN 80.

It has proven convenient at times to refer to the logic contained in software, such as control software 130, to bits, values, elements, symbols, characters, terms, numbers, or the like. It should be borne in mind, however, that all of these and similar terms are to be associated with the appropriate physical quantities and are merely convenient labels applied to these quantities. Further, the manipulations performed by other software, such as control software 130, are often referred to in terms, such as “designating”, “delivering”, or “conveying”, which are commonly associated with mental operations performed by a human operator. No such capability of a human operator is necessary or desirable in most cases of the operations described herein, which form part of the present invention. As indicated herein, these operations are primarily machine operations. Useful machines for performing operations of a preferred embodiment of the present invention include data-processing systems, such as a general-purpose digital computer (computer system 20) or other similar devices. In all cases, the distinction between the method of operations in operating a computer and the method of computation itself should be borne in mind.

The present invention includes logic in the form of software or a program product for processing electrical or other (e.g. mechanical, chemical) physical signals to generate other desired physical signals, and can be implemented via a computer or microcomputer. However, it is not necessary to maintain such a program product within a computer memory or instructions implementing the program product. Such instructions can be maintained within a computer memory location of a computer or dedicated workstation or may be distributed over a network of processing systems. Implementation of the program product described herein is left to the discretion of a particular designer, computer programmer, systems analyst or others similar skilled in the art.

It can be appreciated by those skilled in the art that the program product described herein can be implemented as a software implemented program product (e.g., control software 130 residing in computer memory). The software implemented program product contains logic or logic means in the forms of instructions that when executed on a CPU, carry out the operations depicted in the logic flow diagrams of FIGS. 11 and 12. While the present invention is described in the context of a fully functional on-line system that can be used by a small business to share WAN connectivity, those skilled in the art will further appreciate that the present invention is capable of being distributed as a software-implemented program product in a variety of forms. The present invention applies equally, regardless of the particular type of signal-bearing media utilized to actually carry out the distribution. Examples of signal-bearing media include recordable-type media, such as floppy disks, hard-disk drives and CD ROM's, and transmission-type media, such as digital and analog communication links.

Preferred implementations of the invention can include implementations to execute the program product described herein as a software-implemented program product (or program product) residing in a memory of microcomputer. Until required by a microcomputer, the set of instructions may be stored as a program product in computer memory. For example, the set of instructions may be stored as a program product in a disk drive attached to a microcomputer (which may include a removable memory such as an optical disk or floppy disk for eventual use in the disk drive).

The program product can also be stored at another computer and transmitted, when desired, to a user's workstation by an internal or external network. Those skilled in the art will appreciate that the physical storage of the sets of instructions physically changes the medium upon which it is stored so that the medium carries computer-readable information. The change may be electrical, magnetic, chemical, or some other physical change. While it is convenient to describe the invention in terms of instructions, symbols, characters, or the like, the reader should remember that all of these and similar terms should be associated with the appropriate physical elements.

FIG. 11 is a block diagram illustrating the program product 149, which is at the heart of application server computer 112. Program product 149 contains control software 130 which interacts with a means for storing user configuration and security information 132 and an interface to a WAN 128. Program product 149 allows application server computer 112 to control which end users computers 116 can access a WAN 80 and how they will access WAN 80. Program product 149 is connected from its interface to the WAN 128 by communications link 90 to control center 134. In this way, the application server computer 112 is able to access the control center 134 and provide automated configuration of access to WAN 128.

Control center 134 can interact with program product 149 to determine if program product 149 is an authorized version, requires any maintenance updates, or if it is operating within its license agreement. If control center 134 determines that program product 149 requires any type of maintenance, control center 134 is capable of performing the maintenance remotely through communications link 90, thus, the control center 134 may keep program product 149 properly functioning. Additionally, if control center 134 determines that program product 149 is unauthorized or operating outside of a license agreement, control center 134 will disable program product 149.

FIG. 12 is a block diagram illustrating the various components of the control software 130 that control the functionality of the application server computer 112 to enable it to achieve automated access configuration for users. Control software 130 is adapted to communicate its location to control center 134. This provides program product 149 a method of sharing its location with control center 134 in order to provide control center 134 with the ability of verifying that the program product 149 is operating in an authorized location. Control software 130 also interacts with a logic means for storing user configuration and security information 132 so that it controls who has access and how much access via the user and security information 133. The user and security information 133 may give one person the ability to access many sites while the next person may only be able to access a few specific sites required for their job. Thus, it is possible to tailor the amount of access a person is given to meet the needs of their job.

The control software 130 is further adapted to interact with a fax capability 152. This fax capability 152 allows the program product 149 to replace a fax machine and interact with other fax machines so that paper documents, which are typically transmitted by fax machines, may be transmitted from and received into, the application server computer 112.

Program product 149 also includes logic means for web caching 154. Web caching is a technique, known to those skilled in the art, which allows for previously viewed World Wide Web pages to be stored in memory for faster recall on subsequent viewings. The program product 149 also includes logic means for WAN sharing 156, which allows for multiple end user computers 116 to share a single connection to a WAN 80 such as the Internet. This is useful for helping to control costs and to control access. By only having one entry point, it is possible to protect the end user computers 116 on internal network 114.

The single point of entry is guarded by a logic means for a firewall 158. In one embodiment, the firewall 158 includes a Network Address Translation (NAT) protocol which allows for various types of communications to be allowed to pass at set ports. Typically, World Wide Web addresses will have one set of values or ports while e-mail will use another port and other methods of information sharing on the WAN 80 will use other ports. These ports are familiar to those skilled in the art. Program product 149 includes a logic means for logging IP addresses 144 which maintains a list of all the computers that have communicated with program product 149. Thus, if a problem develops, it is possible to go through the IP log 144 and try to determine the offending computer from the list of computers. Program product 149 also includes logic means for implementing a Virtual Private Network (VPN) 162. A VPN 162 allows for end user computers 116 to communicate securely with computers on a WAN 80. This is useful so that a possible hacker or other person with harmful intent cannot intercept communications over WAN 80. Control software 130 also contains a means of interfacing to the WAN 128 so that it may use a communications link 90 to contact control center 134 or other computers upon WAN 80.

Further, control software 130 interacts with an ID number 160, which is the unique value for each copy of the program product 149. Thus, program product 149 has its own identity or serial number. ID number 160 allows for the control center 134 to verify that program product 149 is a legitimate and valid copy of the program product. Another feature of program product 149 is logic means for utilizing one e-mail domain 137. This allows program product 149 to share e-mail addresses among multiple end user computers 116. It is further obvious to those skilled in the art that program product 149 could include other functions such as web serving, also known as web hosting, so that it can serve web pages, if desired, to other end user computers 116 on the internal network 114, or to external Internet end users 117 across WAN 80. Those skilled in the art will recognize that other embodiments of the invention using any subset of the disclosed features would be possible, depending on the needs of the small business owner and her network.

The first step in acquiring and using an application server computer 112 is to determine the number of users. The number of users determines the number of users accounts to be created. Next, email capabilities are determined by the needs of the small business owner and what domain name will be used. The domain is registered and the locations for email and web services are determined. Once the setup information is determined, it is loaded into the control center 134. When the application server computer 112 is booted for the first time it seeks out a connection to WAN 80. Once application server computer 112 is connected to WAN 80 via communications link 90, the control center 134 recognizes the application server computer 112 and automatically sends the appropriate setup instructions to configure the control software 130. Application server computer 112 is now ready to perform the tasks according to the needs of the small business. The functions the application server computer 112 may be set to perform include: VPN 162, faxing 152, logging IP addresses 144, maintaining user and security information 133, Email sharing 137, maintaining a list of valid IP addresses 146, firewall 158 including NAT 159 capabilities, providing a location signal 148 to the control center 134, and confirming an ID number 160 with the control center 134. In FIG. 13, the functions and content of an application server computer 112 suitable for use with a system for automated configuration of access to the Internet is depicted. Application server computer 112 is connected to a WAN 80 for access to the Internet and is connected to internal network 114 so that end user computers 116 may access information on WAN 80. Firewall 158 controls data packages flowing through application server computer 112 and may limit what type of traffic can get into internal network 114 or outside to WAN 80. The web browser proxy 200 operates on port 8080 to monitor what web sites are being accessed through end user computers 116 and also to cache the web pages 154 so that previously viewed web pages may be accessed without having to go out onto WAN 80.

The Socks proxy 202 is compliant with the Socks 4/5 protocols and operates on port 1080. Socks is a network proxy protocol that enables hosts on one side of a Socks server to gain full access to hosts on the other side of the Socks server without requiring direct IP reachability. Socks redirects connection requests from hosts on opposite sides of the Socks server. The Socks server authenticates and authorizes the request, establishes a proxy connection, and relays data. Socks is commonly used as a network firewall that enables hosts behind the Socks server to gain full access to the Internet, while preventing unauthorized access from the Internet to the internal host.

Another proxy is Real Player proxy 204, operating on port 1090. The Real Player proxy allows real time audio and video to be accessed through a Real Player compatible program by end user computer 116. The file transfer protocol proxy 206 (FTP) operates on port 2021. FTP is used for transferring large files which may be ascii or binary files. Reverse FTP bridge proxy 210 is provided through port 21. The reverse FTP bridge allows FTP access through the gateway to other computers, thus end user computer 116 could supply files, acting as an FTP server, to computers on WAN 80. Telnet proxy 208 utilizes port 23. Telnet applications are applications which simulate a computer session on a remote computer. Thus, end user computer 116 could Telnet into another computer on WAN 80 and the Telnet session would appear as though end user computer 116 was directly logged into another computer on WAN 80.

The Domain Name Service (DNS) forwarding 212 is provided through port 53. A DNS server is needed to operate on the World Wide Web so that commonly used aliases such as www.uspto.gov may be correctly identified to the dotted domain equivalent. A VDO Live proxy 214 may be accessed through port 7000. VDO Live is a type of video and audio delivery protocol which can be used to send and receive audio and video information. Network News Transfer Protocol (NNTP) 216 is accessed through port 119. Usenet newsgroups are accessed through this proxy.

Internet Relay Chat (IRC) proxy 218 is provided through port 6667. Users needing to participate in chat groups may use this protocol to access IRC compliant chat areas. E-mail proxy 220 is transferred through Simple Mail Transfer Protocol (SMTP) and Post Office Protocol 3 (POP3). SMTP is accessed through port 25 and POP3 is accessed through port 110. Other configurable ports 222 are available for other uses as may be deemed necessary by the system administrator. An IP manager administration function 224 is provided to to allow IP addresses to be excluded or allowed, depending on the administrative procedures. The administrator may choose to enable or disable proxies and ports depending on the needs of the system. For example, in a business environment ports which allow chat or games are typically disabled so the network will not be used for nonwork related activities.

A Dynamic Host Configuration Protocol (DHCP) 226 server is also provided. DHCP is an Internet protocol for automating the configuration of computers that use TCP/IP. DHCP can be used to automatically assign IP addresses, to deliver TCP/IP stacked configuration parameters such as the subnet mask and the default router, and to provide other configuration information such as the address for printers, time and news servers. DHCP provides a mechanism through which computers using TCP/IP can obtain protocol configuration parameters automatically through the network. DHCP is an open standard. Using DHCP, a network administrator can avoid hands-on configuration of individual computers through complex and confusing setup applications. Instead, those computers can obtain all required configuration parameters automatically, without manual intervention, from a centrally managed DHCP server 226.

While the invention has been described with reference to illustrative embodiments, this description is not intended to be construed in a limiting sense. Various modifications in combinations of the illustrative embodiments, as well as other embodiments of the invention, will be apparent to persons skilled in the art upon reference to the description.

What is claimed is:

1. A system for automated configuration of access to a wide area network comprising:
an application server computer comprising:
an interface to said wide area network;
control software for detecting the type of connection available for use by said system over said interface and for configuring use of said wide area network by one or more users; and
means for storing user configuration and security information;
a communications link providing a signaling pathway for said computer over said wide area network through said interface; and
a control center accessible by said computer over said communications link, said control center adapted to automatically detect the presence of said computer on said wide area network area it is connected to said communications link via said interface, said control center further adapted to provide automatic registration, configuration and protection of said computer so that said one or more users are able to achieve access to and use of said wide area network.

2. The system of claim 1 wherein said communications link is a T1 phone line.

3. The system of claim 1 wherein said communications link is a digital subscriber line (D.L.).

4. The system of claim 1 wherein said communications link is an Integrated Services Digital Network (ISDN).

5. The system of claim 1 wherein said communications link is a Cable wide area network connection.

6. The system of claim 1 wherein said communications link is a wireless wide area network connection.

7. The system of claim 1 wherein said communications link is an analog telephone line.

8. The system of claim 1 wherein said control software further comprises a firewall to protect users from unauthorized access.

9. The system of claim 8 wherein said firewall further comprises a network address translator (NAT) protocol.

10. The system of claim 1 wherein said control software further comprises a virus protection program.

11. The system of claim 1 wherein said application server computer further comprises a means for facsimile (Fax) communications.

12. The system of claim 1 wherein said application server computer further comprises means for utilizing one e-mail domain.

13. The system of claim 1 wherein said application server computer further comprises means for retrieving e-mail for users from said wide area network.

14. The system of claim 1 wherein said application server computer further comprises a virtual private network which allows several computers to communicate via said wide area network.

15. The system of claim 1 wherein said application server computer further comprises a means for caching world wide web pages to allow fast recall of previously visited web pages.

16. The system of claim 1 wherein said application server computer further comprises means for users to connect to said wide area network simultaneously through an Internet Service Provider.

17. The system of claim 1 wherein said control center further comprises means to update said application server computer.

18. The system of claim 1 wherein said control center further comprises means to troubleshoot said application server computer.

19. An application server computer for automating access to a wide area network by one or more users comprising:
an interface to said wide area network;
control software for detecting the type of connection available for use through said interface and for configuring use of said wide area network by one or more users; and
means for storing user configuration and security information,
wherein said control software is adapted to cause said computer to automatically communicate with a remote control center through said interface in order to configure access by said one or more users to said wide area network.

20. The computer of claim 19 further comprising means for receiving updates from said control center.

21. The computer of claim 19 further comprising means for receiving troubleshooting from said control center.

22. The computer of claim 19 wherein said control software further comprises a firewall to protect users from unauthorized access.

23. The computer of claim 22 wherein said firewall further comprises a network address translator (NAT) protocol.

24. The computer of claim 19 wherein said control software further comprises a virus protection program.

25. The computer of claim 19 further comprising means for facsimile (Fax) communications.

26. The computer of claim 19 further comprising means for utilizing one e-mail domain.

27. The computer of claim 19 further comprising means for retrieving e-mail for said users from said wide area network.

28. The computer of claim 19 further comprising a virtual private network which allows several computers to communicate via said wide area network without.

29. The computer of claim 19 further comprising means for caching world wide web pages to allow fast recall of previously visited web pages.

30. The computer of claim 19 further comprising means for said users to connect to said wide area network simultaneously through an Internet Service Provider.

31. The computer of claim 19 further comprising means for accepting a Global Positioning Satellite Location signal.

32. The computer of claim 31 further comprising means for communicating said location signal to said control center.

33. A program product residing in a computer and adapted to cause said computer to achieve automated configuration of access to a wide area network by one or more users, said program product comprising:
logic means for interfacing to said wide area network;
logic means for detecting the type of connection available for use by said system over said interface and for configuring use of said wide area network by one or more users; and
logic means for storing user configuration and security information.

34. The program product of claim 33 further comprising logic means for a firewall to protect users from unauthorized access.

35. The program product of claim 34 wherein said logic means for a firewall further comprises logic means for a network address translator (NAT) protocol.

36. The program product of claim 33 further comprising logic means for virus protection.

37. The program product of claim 33 further comprising logic means for facsimile (Fax) communications.

38. The program product of claim 33 further comprising logic means for utilizing one e-mail domain.

39. The program product of claim 33 further comprising logic means for retrieving e-mail for said users from said wide area network.

40. The program product of claim 33 further comprising logic means for a virtual private network.

41. The program product of claim 33 further comprising a logic means for caching world wide web pages to allow fast recall of previously visited pages.

42. The program product of claim 33 further comprising a unique identification number.

43. The program product of claim 42 further comprising logic means for communicating with a control center.

44. The program product of claim 43 further comprising a logic means for confirming said unique identification number with said control center.

45. The program product of claim 44 further comprising a logic means for logging IP addresses of computers communicating with said program product over said wide area network.
